(19) United States
(12) Patent Application Publication
(10) Pub. No.: US 2013/0086278 A1
(43) Pub. Date: Apr. 4, 2013

(54) PEER-TO-PEER SYSTEM

(71) Applicant: Christian Schmidt, Augsburg (DE)

(72) Inventor: Christian Schmidt, Augsburg (DE)

(73) Assignee: NOKIA SIEMENS NETWORKS OY, Espoo (FI)

(21) Appl. No.: 13/703,196

(22) PCT Filed: Jun. 17, 2010
(86) PCT No.: PCT/EP2010/058553

§ 371 Date: Dec. 10, 2012

(51) Int. Cl. H04L 29/06

(52) U.S. Cl. CPC H04L 65/4076
USPC 709/231

(57) ABSTRACT

The present invention relates to methods and apparatus for providing an improved peer-to-peer system, in particular, to providing live streams. A tracker may receive a report from one or more first peers wherein the report includes one or more quality of service measurements relating to a first live stream of a broadcast. The tracker may receive a request from a second peer for the broadcast and the tracker determines a source of a second live stream for the broadcast based on the received quality of service measurements. The tracker may then inform the second peer of the determined source.

The present invention relates to providing an improved Peer-to-Peer system and, in particular, an improved Peer-to-Peer system for live streaming.

Peer-to-Peer (P2P) networks typically have a distributed network architecture which includes several peers that receive resources as well as supply resources directly to other peers. The number of peers in a P2P network may range from a few peers to thousands of peers (if not more).

In this respect, P2P networks are most well known for implementing file sharing systems where files can be both distributed and received by each of the peers in the P2P network which is in contrast to the traditional client-server model where typically servers supply the files and clients receive the files.

Other uses of P2P networks may include, for example, distribution of applications, or data, distributed processing of large tasks, and so on.

However, the use of P2P networks for live streaming of a broadcast is a new application which introduces new problems. Thus, there is a need for an improved P2P system that enables live streaming over P2P networks which provides an effective user experience and an effective determination of a source of the live streaming. Accordingly, the present invention seeks to address at least in part the problems and needs mentioned hereinabove.

According to a first aspect of the present invention there is provided a method comprising the steps of: receiving a report from one or more first peers wherein the report includes one or more quality of service measurements relating to a first live stream of a broadcast; receiving a request from a second peer for the broadcast; determining a source of a second live stream for the broadcast based on the received quality of service measurements; and informing the second peer of the determined source.

The method may be implemented by a tracker in a peer-to-peer (P2P) network. Therefore, a source for a live stream of a broadcast requested by a second peer can be determined based on quality of service measurements provided by the first peers receiving a first live stream of the broadcast. The second peer can then be informed of the determined source so that the second peer may obtain or receive a live stream of the requested broadcast. This may advantageously enhance the quality of the second live stream that may be provided to the second peer requesting the broadcast and therefore may enhance a user experience of the peer.

The peers may include a user device, for example, personal computers, laptops, mobile devices, and so on, which may be able to connect to a P2P network and may be able to transmit and/or receive live streams. A peer may include the user using or viewing the user device.

A broadcast may be of a live event (e.g. a sporting event, concert, news report, etc) that is occurring or happening. Each broadcast may have several corresponding live streams as in the P2P network there may be multiple sources of live streams for a particular broadcast that may be received by several peers.

Live streams may relate to providing or distributing audio and/or video of the broadcast of an event, e.g. a sporting event, concert, programs including, news, factual, drama, and so on, at substantially the moment in time the event is occurring or happening over the P2P network. Thus, a broadcast and the corresponding live streams may have a real-time aspect as the peers want to receive the live stream of the broadcast of the event whilst the event is happening.

The step of determining the source may further comprise applying weighting values to one or more of the quality of service measurements; and aggregating the weighting values to determine an optimal source of the second live stream. The weighting values applied may be the same. By applying weighting values the quality of service measurements relating to the first live streams then the different quality of service measurements may be prioritised. The quality of service measurements may be prioritised by the peer, the tracker or a combination thereof. The quality of service measurements may include any measurements that may be used to determine the quality of the first live streams that may be received by the first peers. For example, the quality of service measurements may include an end-to-end delay, a delay on one or more parts of the path that the live stream traverses through the P2P network, ratio of lost and/or missing and/or faulty packets received by the first peers, quality of the audio and/or video of the broadcast, and so on.

The request from the second peer may include one or more service preferences and the step of determining the source is further based on the one or more service preferences. The service preferences may be provided by the second peer or selected from a predefined list of service preferences which may be provided by the tracker. The service preferences may be dependent on the broadcast or the event being the subject of the broadcast. For example, if the event is a live sporting event then the service preferences may include a shortest delay. If the event is a live concert then the service preferences may include the highest audio quality. Thus, the service preferences may be considered when determining the source to provide a live stream of the broadcast to the peer requesting the broadcast. The service preferences may be used to prioritise the quality of service measurements.

The step of determining the source may be further based on one or more predefined policies. The predefined policies may be defined and stored by the tracker. The predefined policies may be defined by a peer. The predefined policies may define rules or priorities that may or may not relate directly to the quality of service measurements. For example, a policy may define that the source should be geographically located close to the peer requesting the broadcast. The geographical location of the source and a peer may relate to one or more quality of service measurements, for example, the greater the distance between the source and the peer may affect the delay.

The step of informing the second peer of the determined source may include providing a network address of the determined source. Once a source of a live stream for the requested broadcast has been determined based on the quality of service measurements then the second peer is informed of the network address of the determined source so that the second peer can communicate with the determined source to enable the second peer to receive a live stream of the broadcast.

The first stream may be the same as the second stream, for example, a first peer may receive the first stream and distribute as a source the same stream as the second stream. The first stream may be received by a first peer and the first peer may generate the second stream based on the first stream. A source may not receive a first stream but generate the second stream, for example, the source may be a distributor which may be an entity that is capturing and providing or distributing a broadcast.

The method may further include receiving an indication of a broadcast that may be available to be distributed to one or more peers. The method may include receiving an indication of a source. The method may include identifying and storing information or details relating to a source and/or a peer receiving a live stream. The method may further include monitoring, coordinating, maintaining or tracking broadcasts and/or live streams.

According to a second aspect of the present invention there is provided an apparatus comprising: a first input adapted to receive a report from one or more first peers wherein the report includes one or more quality of service measurements relating to a first live stream of a broadcast; a second input adapted to receive a request from a second peer for the broadcast; a processor adapted to determine a source of a second live stream for the broadcast based on the received quality of service measurements; and an output adapted to inform the second peer of the determined source.

According to a third aspect of the present invention there is provided an apparatus adapted to: receive a report from one or more first peers wherein the report includes one or more quality of service measurements relating to a first live stream of a broadcast; receive a request from a second peer for the broadcast; determine a source of a second live stream for the broadcast based on the received quality of service measurements; and inform the second peer of the determined source.

The processor may be further adapted to apply weighting values to one or more of the quality of service measurements; and aggregate the weighting values to determine an optimal source of the second live stream. The weighting values applied may all be the same, different or any combination thereof.

The request from the second peer may include one or more service preferences and the processor may be further adapted to determine the source is further based on the one or more service preferences.

The processor may be further adapted to determine the source based on one or more predefined policies. The apparatus may further comprise storing means adapted to store the predefined policies.

The output may further adapted to inform the second peer of the determined source by providing a network address of the determined source.

The apparatus may include a further input adapted to receive an indication of a broadcast that may be available to be distributed to one or more peers. The apparatus may include another input adapted to receive an indication of a source. The apparatus may include a further processor adapted to identify and store information or details relating to a source and/or a peer receiving a live stream. The apparatus may further include further processors adapted to monitor, coordinate, maintain or track broadcasts and/or live streams.

The inputs described hereinabove may be the same input, different inputs or any combination thereof. The outputs described hereinabove may be the same output, different outputs or any combination thereof. The processors described hereinabove may be the same processor, different processors or any combination thereof.

The apparatus may be a tracker. The apparatus may be a centralised server, computing device or functionality implemented on a system.

The apparatus may be adapted by software, hardware or any combination thereof. The apparatus may be adapted to perform any or all of the functions or features in accordance with the aspects of the present invention.

According to a fourth aspect of the present invention there is provided a computer program product comprising computer readable executable code for: receiving a report from one or more first peers wherein the report includes one or more quality of service measurements relating to a first live stream of a broadcast; receiving a request from a second peer for the broadcast; determining a source of a second live stream for the broadcast based on the received quality of service measurements; and informing the second peer of the determined source.

The computer program product may further comprise computer readable executable code for performing any or all of the functions in accordance with the aspects of the invention.

According to a fifth aspect of the present invention there is provided a method comprising the steps of: receiving a live stream of a broadcast; determining one or more quality of service measurements for the live stream; generating a report based on the one or more quality of service measurements; and transmitting the report to a tracker.

The method may be implemented by a peer. Thus, the peer receiving a live stream of a broadcast can take or determine quality of service measurements relating to the live stream being received and reporting the quality of service measurements to a tracker such that the tracker may store and utilise the quality of service measurements.

According to a sixth aspect of the present invention there is provided an apparatus comprising: an input adapted to receive a live stream of a broadcast; a first processor adapted to determine one or more quality of service measurements for the live stream; a second processor adapted to generate a report based on the one or more quality of service measurements; and an output adapted to transmit the report to a tracker.

According to a seventh aspect of the present invention there is provided an apparatus adapted to: receive a live stream of a broadcast; determine one or more quality of service measurements for the live stream; generate a report based on the one or more quality of service measurements; and transmit the report to a tracker.

The first processor and second processor may be the same processor or different processors. The apparatus may be a computing device, for example, a mobile device, personal computer, laptop, and so on. The apparatus may be able to connect to or communicate with a P2P network and may receive and transmit a live stream of a broadcast.

The apparatus may be adapted by software, hardware or any combination thereof. The apparatus may be adapted to perform any or all of the functions or features in accordance with the aspects of the present invention.

According to an eighth aspect of the present invention there is provided a computer program product comprising computer readable executable code for: receiving a live stream of a broadcast; determining one or more quality of service measurements for the live stream; generating a report based on the one or more quality of service measurements; and transmitting the report to a tracker.

The computer program product may further comprise computer readable executable code for performing any or all of the functions in accordance with the aspects of the invention.

Embodiments of the present invention will now be explained, by way of example only, and with reference to the accompanying drawing in which:

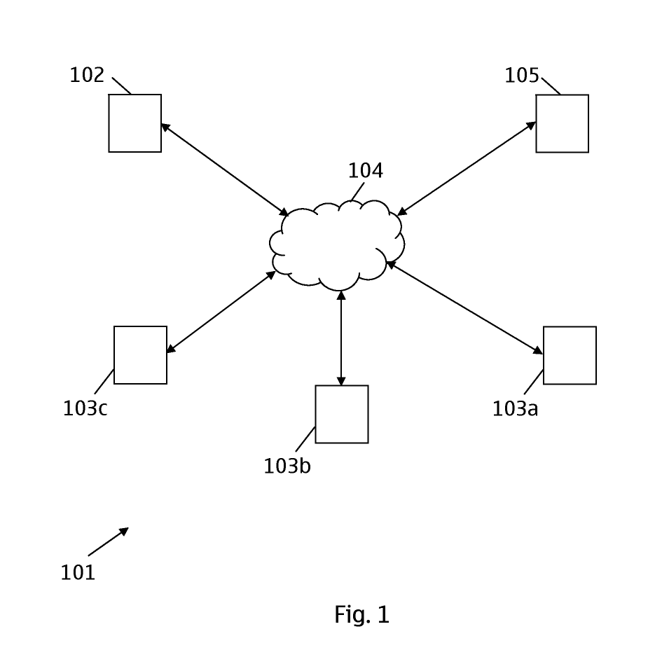

FIG. 1 shows a simplified block diagram of a system in accordance with many embodiments of the present invention.

As shown in FIG. 1, a Peer-to-Peer (P2P) system 101 may include a tracker 102, one or more peers 103 and one or more distributors 105. The tracker 102, one or more peers 103 and the one or more distributors 105 may be operatively connected to each other by a network 104.

The tracker 102 coordinates and tracks live streams relating to one or more broadcasts that are being received by the one or more peers 103. The tracker 102 may also maintain information relating to each of the peers 103 receiving a live stream and of sources supplying or distributing live streams, where the sources may include both the distributors 105 and any peers 103 receiving a live stream. In particular, the tracker 102 may identify the network location of each peer 103 receiving a live stream and of each source. The tracker 102 may be a centralised server, may be a further computing device or server, or may be functionality on a system, e.g. a management system in the network 104.

In a P2P system 101 there will be one or more peers 103. In FIG. 1, three peers 103a, 103b and 103c are shown however, it may be expected that there would be tens, hundreds, thousands if not more peers 103 in any one P2P system 101. The peers 103 are typically user devices, for example, personal computers, laptops, mobile devices, and so on, which are able to connect to the P2P system 101 via network 104 and are able to transmit and/or receive live streams. The peers 103 may both receive a live stream, e.g. a consumer, and distribute a live stream, e.g. a source. The P2P system 101 may cover any geographical area, for example, the P2P system 101 may be global, regional, national o local and therefore the peers 103 and distributors 105 may be located anywhere on the planet.

The distributor 105 may be an entity that solely distributes live streams relating to a broadcast and therefore is only a source of live streams. For example, the distributor 105 may be an event organiser that broadcasts an event (e.g. a sporting event, concert, and so on), a Television company broadcasting programs, and so on. Each broadcast may have several corresponding live streams as in the P2P system 101 there may be multiple sources of live streams for a particular broadcast.

Live streams relate to providing or distributing audio and/or video of the broadcast of an event, e.g. a sporting event, concert, programs including, news, factual, drama, and so on, at substantially the moment in time the event is occurring or happening over the network 104. Thus, a broadcast and the corresponding live streams have a real-time aspect as the peers want to receive the broadcast of the event whilst the event is happening.

The network 104 may be any network that enables the peers 103, the tracker 102 and the distributor 105 to be operatively connected. For example, the network 104 may be the Internet.

With reference to FIG. 1, an example will be described in accordance with many if the embodiments. The distributor 105 may be an entity that is distributing effectively or substantially in real-time a broadcast of a live event, e.g. a live football match. A first peer 103a, e.g. a personal computer, is receiving over the network 104 a live stream of the broadcast of the live football match from the distributor 105. The first peer 103a may also become a source of a live stream for the broadcast. A second peer 103b is receiving over the network 104 a live stream of the football match from the first peer 103a (thus, the first peer 103a is a source for the second peer 103b). The second peer 103b may also become a source of a live stream of the broadcast of the football match.

The tracker 102 coordinates and tracks the live streams relating to the broadcast that are being distributed or supplied over the network 104. The tracker 102 maintains information relating to each of the first and second peers 103a, 103b receiving a live stream and of sources that are, or can, distribute live streams of the broadcast, which, in this example, includes the distributor 105 as well as the first and second peers 103a, 103b. In particular, the tracker 102 identifies or maintains the network location of the first and second peers 103a, 103b and the distributor 105.

The distributor 105 when starting to distribute, or prior to a planned distribution of, a broadcast may inform the tracker 102 of the broadcast and therefore inform the tracker 102 that the distributor 105 is a source of a live stream of the broadcast. The distributor 105 may inform the tracker 102 of the broadcast via, for example, a message or by registering the broadcast using a web address of the tracker 102. The tracker 102 may maintain information relating to the source, e.g. the distributor 105, of a live stream of the broadcast. The first and second peers 103a, 103b will have received contact details of a selected source of a live stream of the broadcast from the tracker 102 in order to receive the live stream of the football match. The first and second peers 103a, 103b will have requested the live stream from the tracker 102 and the process of the tracker 102 providing the contact details of a source may follow the mechanism described hereinbelow. Once the first and second peers 103a, 103b are receiving a live stream then the tracker 102 maintains information relating to the first and second peers 103a, 103b as further sources of a live stream of the broadcast of the live football match. The tracker 102 may automatically register peers 103a, 103b as sources once they receive a live stream or the tracker 102 may wait until each of the peers 10sa, 103b inform the tracker 102 that they can be a source of a live stream of the broadcast.

When a peer receives a live stream the peer may take various Quality of Service (QoS) measurements relating to the live stream. For example, the peer may measure an end-to-end delay, a delay on part or the entire path, a ratio of lost or faulty packets received, quality of the audio and/or video relating to the live stream, and so on.

In order to determine or measure an end-to-end delay, e.g. a delay in receiving packets from a source to the peer, one example may be an extension of the Real Time Protocol (RTP) time stamp to enable the end-to end delay to be measured. Other examples may include adding information to the packet, as the packet is transmitted through the network, such that the end-to-end delay may be determined or measured by the peer receiving the live stream.

In order to determine or measure the ratio of the lost/faulty packets the peer receiving the live stream can make the necessary measurements based on the packets received.

Thus, in this example, the first peer 103a receiving the live stream from distributor 105 will determine the QoS measurements relating to the received live stream it is receiving. The second peer 103b receiving the live stream from the first peer 103a will determine the QoS measurements relating to the received live stream it is receiving. The first and second peers 103a, 103b may transmit the QoS measurements to the tracker 102 which may store the QoS measurements. The QoS measurements may be stored by the tracker 102 in relation to one or more of the sources, the geographical area of the source and/or peer, the live stream, and so on such that the tracker 102 may be able to utilise and analyse the QoS measurements when determining or selecting a source for any further peers that request to receive the broadcast.

The first and second peers 103a, 103b may report or transmit the QoS measurements to the tracker 102 at the time that the peers 103a, 103b start receiving or consuming the respective live streams. The peers 103a, 103b may then transmit further QoS measurements to the tracker 102 if and when any changes occur to the QoS measurements relating to the respective live stream each peer 103a, 103b receives.

The tracker 102 may also include or store one or more predefined policies. Each of the predefined policies may define one or more rules or priorities which may be applied by the tracker 102 when determining a source of a live stream for a peer. For example, a policy may define that the source should be located near to the geographical area of the peer requesting a live stream. One or more policies may define predetermined classes of service relating to a live stream and/or a source. As will be appreciated, the one or more policies may describe or define any number of rules or priorities that may be applied to the selection of a source of a live stream for a peer.

In the described example, a third peer 103c wishes to receive the broadcast of the live football match. The third peer 103c may interact with the tracker 102 in order to request a source of a live stream of the broadcast of the football match. For example, the third peer 103c may interact with the tracker 102 by directing a web browser on a peer device to the network address of the tracker 102 and completing or filling in details on a web page in order to request the broadcast. Alternatively, the peer 103c may transmit a message to the tracker 102 requesting a particular broadcast.

The request for a live stream may further include service preferences relating to the broadcast that the peer 103c wishes to receive. The service preferences selected by the peer 103c and provided to the tracker 102 may be dependent on the type of broadcast and therefore may be different for each type of broadcast. For example, if the broadcast related to a live sporting event, e.g. the football match, then the peer 103c may wish to receive a live stream with the shortest delay. In another example, if the broadcast related to a concert then the peer 103c may wish to receive a live stream with the highest quality audio.

As described hereinabove, different classes of service may be predefined or predetermined as, for example, a policy in the tracker 102. For example, a class of service relating to a broadcast of a live sporting event may be defined as including a preference for a shortest delay live stream thereby enabling the peer to select a class of service rather than selecting individual preferences.

Therefore, the service preferences provided by a peer may include one or more individual preferences or include one or more classes of service. The peer may also indicate a priority associated with each preference.

If the peer does not indicate or provide a service preference then the tracker 102 may have a policy defined which defaults to a set list of one or more preferences, e.g. may default to a predefined class of service or to one or more particular preferences.

As will be appreciated, the service preferences may cover a wide range of preferences and include any number of preferences including, for example, QoS preferences, cost, location, and so on.

On receipt of the request for a broadcast from the peer 103c, the tracker 102 selects or determines a source to provide a live stream of the requested broadcast. The tracker 102 may select a source based on one or more of the stored policies, the service preferences if provided by the requesting peer 103c, or the stored QoS measurements relating to a source and/or live stream provided by other peers receiving live streams of the broadcast.

In this described example, the tracker 102 applies a policy which defines a priority as being the geographical distance of the source from the peer 103c requesting the broadcast where the shorter the distance the more favourable the source. In order to prioritise available sources the tracker may apply a weighting value to each source based on their location, for example, a source closer to the peer requesting the broadcast may receive a higher weighting value. As mentioned hereinabove, any number of policies (or even none) may be applied where the policies define any number of rules or priorities which may be taken into account when the tracker 102 determines a particular source to provide a live stream to the requesting peer.

Based on the received QoS measurements the tracker 102 can also determine or identify a source that best matches the service preferences for the broadcast requested by the peer 103c. For example, the tracker 102 may apply a weighting value to each the QoS measurements relating to each source and/or live stream based on the service preferences.

The tracker 102 may then aggregate the weighting values of any policies applied with the QoS measurements and select the best available source which can provide or distribute to peer 103c a live stream of the requested broadcast.

In the above example, the tracker 102 applies weighting values and aggregates those weighting values however, as will be appreciated other mechanisms for determining or selecting the best available source may be used to take into consideration any policies applied along with service preferences and the QoS measurements.

In this described example, peer 103c when requesting the broadcast of the live football match indicates that their service preference is the shortest delay and the policy applied by the tracker 102 is that the source should be geographically close to peer 103c. Thus, the tracker 102 will prioritise the sources, in this example, based on the delay of a live stream and on the location of the source. In the example, there are three possible sources of a live stream being the distributor 105, the first peer 103a and the second peer 103b.

In order to simplify this example the tracker 102 may utilise a weighting range of 1 to 10 where 1 is the worst and 10 is the best to prioritise each of the priorities, which in this case are location and delay.

In this example the distributor 105 is 200 kilometres from peer 103c, the first peer 103a is 60 kilometres from peer 103c and the second peer 103b 50 kilometres from peer 103c. Accordingly, the tracker 102 may apply weighting values of 2 for the distributor 105, 8 for the first peer 103a and 10 for the second peer 103b.

In terms of the shortest delay, in this example the tracker 102 will determine from the stored QoS measurements for each live stream and/or source that the shortest delay relates to a live stream that could be distributed by the first peer 103a, the second shortest delay relates to a live stream that could be distributed by the distributor 105 and the third shortest delay relates to a live stream that could be distributed by the second peer 103b. Thus, the tracker 102 may apply weighting values of 10 to the first peer 103a, 7 to the distributor 105 and 4 to the second peer 103b.

The tracker 102 may then aggregate the weighting values for each source in order to determine the best available source of a live stream for the third peer 103c. Thus, the aggregated weightings are, in this example, 9 for the distributor 105, 18 for the first peer 103a and 14 for the second peer 103b. As such, the tracker 102 determines that the first peer 103a is the best source based on a localisation policy and also based on the QoS measurements received and stored at the tracker 102 relating to the live streams and/or sources.

Once the tracker 102 has determined the best available or most optimal source to provide a live stream of the requested broadcast, the tracker 102 informs the requesting peer 103c of the contact details of the selected source. Thus, in this example, as the tracker 102 determines that the first peer 103a is the best available source then the tracker 102 informs the third peer 103c (the peer requesting the broadcast) of the contact details of the first peer 103a so that the third peer 103c can obtain and receive a live stream of the broadcast of the live football match.

If peer 103c is interacting with the tracker 102 via a web browser then the tracker 102 may provide or inform peer 103c of the selected source by a selectable link, by a HTTP redirect, and so on. Alternatively, the tracker 102 may transmit a message to peer 103c in order to inform peer 103c of the contact details, e.g. network address of the selected source. The message may include the source as a selectable link.

For ease and simplification of the example, only two aspects were prioritised (location and delay) and an arbitrary and simple weighting system was applied by the tracker. However, as will be appreciated, any number of aspects may be prioritised and any weighting system applied to determine the best available source based on the QoS measurements. Moreover, the tracker 102 may apply any mechanism to select or determine the best available source based on the QoS measurements provided by peers that are receiving a live stream of a broadcast.

Accordingly, in many embodiments of the present invention a source of a live stream of a broadcast may be determined based on the quality of service measurements of other live streams of the broadcast in the P2P system. Therefore, a quality of the live streams provided to a peer requesting a broadcast can be improved enhancing the user experience.

By determining a source based on the quality of service measurements of live streams improves the predictability of the quality of the live stream. This is particularly advantageous, where in a P2P system each peer may be part of a chain of peers receiving and distributing or transmitting a live stream where each peer in the chain can have a negative influence on the reliability and quality of the stream by, for example, having a slow device, increasing delay, a filled downlink or uplink, an unreliable connection, and so on. Thus, by considering the quality of service measurements for live streams in the P2P network the selection or determination of a source that can provide the best quality live stream can be made for a peer requesting a broadcast, which is advantageous when considering broadcasts of live events.

While preferred embodiments of the invention have been shown and described, it will be understood that such embodiments are described by way of example only. Numerous variations, changes and substitutions will occur to those skilled in the art without departing from the scope of the present invention as defined by the appended claims. Accordingly, it is intended that the following claims cover all such variations or equivalents as fall within the spirit and the scope of the invention.

1. A method comprising the steps of:
receiving a report from one or more first peers wherein said report includes one or more quality of service measurements relating to a first live stream of a broadcast;
receiving a request from a second peer for said broadcast;
determining a source of a second live stream for said broadcast based on said received quality of service measurements; and
informing said second peer of said determined source.

2. The method as claimed in claim 1 in which said step of determining said source further comprises:
applying weighting values to one or more of said quality of service measurements; and
aggregating said weighting values to determine an optimal source of said second live stream.

3. The method as claimed in claim 1 which said request from said second peer includes one or more service preferences and said step of determining said source is further based on said one or more service preferences.

4. The method as claimed in claim 1 in which said step of determining said source is further based on one or more predefined policies.

5. The method as claimed in claim 1 in which said step of informing said second peer of said determined source includes providing a network address of said determined source.

6. An apparatus comprising:
a first input adapted to receive a report from one or more first peers wherein said report includes one or more quality of service measurements relating to a first live stream of a broadcast;
a second input adapted to receive a request from a second peer for said broadcast;
a processor adapted to determine a source of a second live stream for said broadcast based on said received quality of service measurements; and
an output adapted to inform said second peer of said determined source.

7. The apparatus as claimed in claim 6 in which said processor is further adapted to:
apply weighting values to one or more of said quality of service measurements; and
aggregate said weighting values to determine an optimal source of said second live stream.

8. The apparatus as claimed in claim 6 which said request from said second peer includes one or more service preferences and said processor is further adapted to determine said source is further based on said one or more service preferences.

9. The apparatus as claimed in claim 6 in which said processor is further adapted to determine said source based on one or more predefined policies.

10. The apparatus as claimed in claim 6 in which said output is further adapted to inform said second peer of said determined source by providing a network address of said determined source.

11. A computer program product comprising computer readable executable code for:
receiving a report from one or more first peers wherein said report includes one or more quality of service measurements relating to a first live stream of a broadcast;
receiving a request from a second peer for said broadcast;
determining a source of a second live stream for said broadcast based on said received quality of service measurements; and
informing said second peer of said determined source.

12. A method comprising the steps of:
receiving a live stream of a broadcast;
determining one or more quality of service measurements for said live stream;
generating a report based on said one or more quality of service measurements; and
transmitting said report to a tracker.

13. An apparatus comprising:
an input adapted to receive a live stream of a broadcast;
a first processor adapted to determine one or more quality of service measurements for said live stream;
a second processor adapted to generate a report based on said one or more quality of service measurements; and
an output adapted to transmit said report to a tracker.

14. A computer program product comprising computer readable executable code for:
receiving a live stream of a broadcast;
determining one or more quality of service measurements for said live stream;
generating a report based on said one or more quality of service measurements; and
transmitting said report to a tracker.
